(19) United States
(12) Patent Application Publication
(10) Pub. No.: US 2025/0039485 A1
(43) Pub. Date: Jan. 30, 2025

(54) STREAMING-MEDIA SYSTEM WITH PUBLISHER SYSTEM INTEGRATION AND ADVERTISEMENT PRESENTATION FEATURE

(71) Applicant: Roku, Inc., San Jose, CA (US)

(72) Inventors: Walter Edwin Elder, Austin, TX (US); Yun-Yun Fei, Los Angeles, CA (US); Apurva Sharma, Santa Clara, CA (US); Mehul Sanghavi, San Jose, CA (US)

(21) Appl. No.: 18/360,458

(22) Filed: Jul. 27, 2023

(51) Int. Cl. H04N 21/258; H04N 21/431; H04N 21/81

(52) U.S. Cl. CPC H04N 21/25891; H04N 21/25883; H04N 21/4312; H04N 21/812

(57) ABSTRACT

In one aspect, an example method can be used in connection with a streaming-media system comprising a publisher system and a presentation device, wherein the publisher system includes one or more data storage components that store media items, respective media attribute data, and respective advertisements. The method can include: (i) obtaining, from the publisher system, media attribute data; (ii) obtaining user profile data; (iii) using at least (a) the obtained media attribute data and (b) the obtained user profile data, as a basis to select a media item of the publisher system; (iv) obtaining from the publisher system, the advertisement that corresponds with the selected media item; and (v) causing the presentation device to present, within a media selection menu of the presentation device, the obtained advertisement.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method can be used in connection with a streaming-media system comprising a publisher system and a presentation device, wherein the publisher system includes one or more data storage components that store media items, respective media attribute data, and respective advertisements. The method can include: (i) obtaining, from the publisher system, media attribute data; (ii) obtaining user profile data; (iii) using at least (a) the obtained media attribute data and (b) the obtained user profile data, as a basis to select a media item of the publisher system; (iv) obtaining from the publisher system, the advertisement that corresponds with the selected media item; and (v) causing the presentation device to present, within a media selection menu of the presentation device, the obtained advertisement.

In another aspect, an example computing system is disclosed. The computing system includes a processor and a non-transitory computer-readable storage medium having stored thereon program instructions that upon execution by the processor, cause the decision system to perform a set of acts for use in connection with a streaming-media system comprising a publisher system and a presentation device, wherein the publisher system includes one or more data storage components that store media items, respective media attribute data, and respective advertisements. The set of acts can include (i) obtaining, from the publisher system, media attribute data; (ii) obtaining user profile data; (iii) using at least (a) the obtained media attribute data and (b) the obtained user profile data, as a basis to select a media item of the publisher system; (iv) obtaining from the publisher system, the advertisement that corresponds with the selected media item; and (v) causing the presentation device to present, within a media selection menu of the presentation device, the obtained advertisement.

In another aspect, an example non-transitory computer-readable medium is disclosed. The computer-readable medium has stored thereon program instructions that upon execution by a processor, cause a computing system to perform a set of acts for use in connection with a streaming-media system comprising a publisher system and a presentation device, wherein the publisher system includes one or more data storage components that store media items, respective media attribute data, and respective advertisements. The set of acts can include (i) obtaining, from the publisher system, media attribute data; (ii) obtaining user profile data; (iii) using at least (a) the obtained media attribute data and (b) the obtained user profile data, as a basis to select a media item of the publisher system; (iv) obtaining from the publisher system, the advertisement that corresponds with the selected media item; and (v) causing the presentation device to present, within a media selection menu of the presentation device, the obtained advertisement.

### BRIEF DESCRIPTION OF THE DRAWINGS

FIG. 1 is a simplified block diagram of an example streaming-media system in which various described principles can be implemented.

FIG. 2 is a depiction of example media items, respective media attribute data, and respective advertisements.

FIG. 3 is a simplified block diagram of an example computing system in which various described principles can be implemented.

FIG. 4 is a screenshot of an example portion of a media selection menu of a presentation device.

FIG. 5 is a flow chart of an example method.

FIG. 6 is a flow chart of another example method.

### DETAILED DESCRIPTION

### I. Overview

In the context of a streaming-media system, a presentation device can include a user interface, which allows a user to, among other things, navigate through a media selection menu and select one or more media items provided by one or more publishers (sometimes referred to as streaming platforms). For example, the user can select a movie provided by a given publisher by selecting a thumbnail image representing the movie. Based on the user's selection, the presentation device can obtain the selected movie from the publisher and present the movie to the user via the user interface of the presentation device, such that the user can watch the selected movie in a video-on-demand (VOD)-type fashion.

The media selection menu can organize selectable media items in various ways. For example, media items can be grouped and/or sorted (e.g., alphabetically) by title, by publisher, by level of popularity, etc. In some instances, it can be desirable for the menu to separately include one or more advertisements for one or more specific media items, which can be used to draw special attention to certain media item options. This can be desirable for various reasons. For example, for the publisher, this can serve as an opportunity to highlight a specific media item to hopefully improve how many times that media item is selected and presented to users, which can help the publisher monetize that media item. As another example, for the user of the presentation device, this can enhance the user experience and can help the user discover media items of interest. This in turn can also benefit the entity who provides the presentation device, as that entity may generally be interested in attracting both publishers and user to use and/or integrate with its presentation device.

However, although it may be desirable to present advertisements within the media selection menu in these and other contexts, the process of enabling this can be complex and time-consuming. Among other things, it can be challenging to determine which media items to promote to which users, and which advertisements to use for promoting them. In addition, given the nature of arrangement of advertisement systems and presentation devices, it can be challenging to carry out the process of actually obtaining the advertisement and inserting it into the media selection menu in an efficient manner. Indeed, in practice, a given publisher may provide a large number of media items, perhaps thousands or more, and may seek to have some or all of the corresponding advertisements for those media items be selected and presented to a larger number of users, perhaps thousands or more, at various times, positions, etc. From a practical standpoint, enabling this type of functionality at such a large scale may involve a substantial amount of manually-intensive operations, and as a result, it may be impossible or virtually impossible to carry this out.

The disclosed systems and methods help to address these and other issues by, among other things, storing within a publisher system, media items, respective media attribute data, and respective advertisements, and providing a mechanism by which an entity such as a decision system can obtain from the publisher system, this stored information, which the decision system can then obtain and use, together with user profile data, as a basis to select a media item of the publisher system. The decision system can then obtain from that same publisher system, the advertisement that corresponds with the selected media item, and can cause the presentation device to present, within a media selection menu of a presentation device, the obtained advertisement. Thereafter, the decision system can select, based on input received via a user interface of the presentation device, the presented advertisement, and responsive to selecting the presented advertisement, the decision system can obtain, from the publisher system, the media item corresponding to (i.e., promoted by) the advertisement.

In this way, the decision system can use at least information obtained from the publisher system and user profile data to select an advertisement that has been selected specifically for that user and, and both the advertisement and the corresponding media item itself can be obtained from the publisher system, such that they can both can be presented to the user via the presentation device. Specifically, the presentation device can present the advertisement obtained from the publisher in a media selection menu, and then in response to the user selecting that advertisement within that menu, the presentation device can obtain the media item from the publisher, and present it to the user. Among other things, this can provide a simpler and more efficient way to obtain media items and associated advertisements that are specifically targeted to users and to facilitate the insertion of such advertisements within media selection menus. These and other operations and related features and benefits are described in greater detail below.

### II. Example Architecture

### A. Streaming-Media System

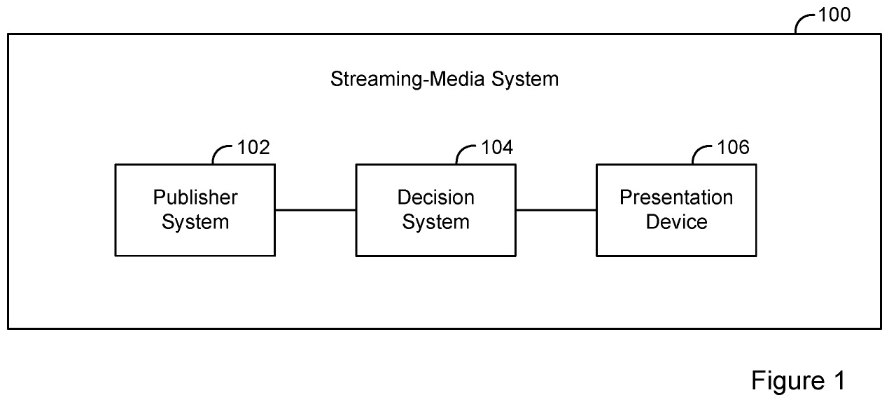

FIG. 1 is a simplified block diagram of an example streaming-media system 100. Generally, the streaming-media system 100 can perform operations related to media. Media can include a video component and/or an audio component and there can be various types and examples of media. For instance, a given media item can be or include a media program such as a movie or a television show episode, among numerous other possibilities.

The streaming-media system 100 can include various components, such as a publisher system 102, a decision engine 104, and/or a presentation device 106. Each of these components can take various forms. For example, the presentation device 106 can take the form of a television and/or a streaming media player, among numerous other possibilities. In practice, one or more of these can be integrated with another. For instance, in one example, a presentation device 106 can take the form of a television with an integrated streaming media player.

Returning back to the streaming-media system 100, the streaming-media system 100 can also include one or more connection mechanisms that connect various components within the streaming-media system 100. For example, the streaming-media system 100 can include the connection mechanisms represented by lines connecting components of the streaming-media system 100, as shown in FIG. 1.

In this disclosure, the term “connection mechanism” means a mechanism that connects and facilitates communication between two or more devices, systems, other entities, and/or components thereof. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

Generally, the publisher system 102 can be associated with a publisher (sometimes referred to as a streaming platform) and can store media, respective metadata, and respective advertisements, in one or more data storage units (e.g., within the publisher system 102).

Media can be represented by media data, which can be generated, stored, and/or organized in various ways and according to various formats and/or protocols, using any related techniques now know or later discovered. For example, the media can be generated by using a camera, a microphone, and/or other equipment to capture or record a live-action event. In other examples, the media can be synthetically generated, such as by using any related media generation techniques now know or later discovered.

As noted above, media data can also be stored and/or organized in various ways. For example, the media data can be stored and organized as a Multimedia Database Management System (MDMS) and/or in various digital file formats, such as the MPEG-4 format, among numerous other possibilities.

The media data can represent the media by specifying various properties of the media, such as video properties (e.g., luminance, brightness, and/or chrominance values), audio properties, and/or derivatives thereof. In some instances, the media data can be used to generate the represented media. But in other instances, the media data can be a fingerprint or signature of the media, which represents the media and/or certain characteristics of the media and which can be used for various purposes (e.g., to identify the media or characteristics thereof), but which is not sufficient at least on its own to generate the represented media.

In some instances, media can include or be associated with metadata, which can also be stored in one or more data storage units (e.g., within the publisher system 102). There can be various types of metadata. In the case where the media includes video and audio, the audio may generally be intended to be presented in sync together with the video. To help facilitate this, the media data can include metadata that associates portions of the video with corresponding portions of the audio. For example, the metadata can associate a given frame or frames of video with a corresponding portion of audio. In some cases, audio can be organized into one or more different channels or tracks, each of which can be selectively turned on or off, or otherwise controlled. Video data can also include other types of metadata associated with the video.

Another example of media metadata is media attribute data, which is information associated with or representative of the media. For example, for a given media item, media attribute data could be or include a media item identifier, title, description, rating, genre, duration, popularity ranking, and/or list of associated actors, actresses, directors, producers, or the like. There can be various other types of media attribute data as well.

In some instances, media can include or be associated with an advertisement intended to promote the media. For example, in the case of a media item that is a movie or television show episode, the advertisement can be an advertisement for that movie or television show episode. An advertisement can take various forms, such an image or a (typically relatively short) video and can have various shapes, sizes, aspect ratios, etc. In some instances, a given media item may be associated with multiple advertisements (e.g., each having differing content, or a different size, aspect ratio, etc.), and as such, a given media item can correspond with a set of multiple advertisements.

The one or more data storage units of the publisher system 102 can thus store media items, respective media attribute data, and respective advertisements. In some instances, the data storage unit can further store mapping data that maps media items to respective media attribute data and/or to respective advertisement(s).

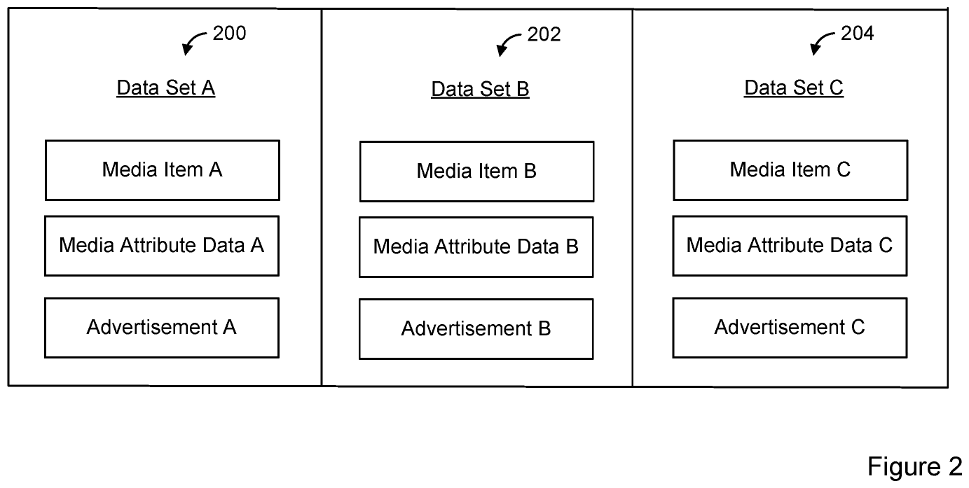

FIG. 2 is a depiction of examples of media items, respective media attribute data, and respective advertisements. As shown, data set A 200 includes a media item A, respective media attribute data A, and respective advertisement A. For example, the media item A could be a given movie, media attribute data A could be media attribute data that includes the title of that movie (among other things), and the advertisement A could be an advertisement for that movie, perhaps in the form of a rectangular-shaped image representing the movie. Likewise, data set B 202 includes a media item B, respective media attribute data B, and advertisement B. And data set C 204 includes a media item C, respective media attribute data C, and advertisement C. As discussed above, in some examples, a given data set may include a set of advertisements. As such, the advertisement A could instead of a set of advertisements A, for instance, and so on.

For the sake of clarity, it should be noted that the example provided in FIG. 2 is for illustration purposes only. In practice, it is likely that a given publisher system 102 will include much larger data sets and/or with much more detailed data (e.g., with many media content attributes for each media item, for instance). As such, in practice, streaming-media system 100 can be of a much larger scale than suggested by the examples shown in the various figures. Indeed, in some examples, the streaming-media system 100 can allow for each of multiple publishers to provide a large number of media items, perhaps thousands or more, and may further allow for advertisements for those media items to be presented to a larger number of users, perhaps thousands or more, at various times and in various positions within media selection menus of presentation devices.

Generally, the decision engine 104 can be associated with a provider of the presentation device 106 and can perform operations related to obtaining media attribute data and/or user profile data, selecting media items and/or advertisements, and facilitating the presentation of those media items and advertisements via the presentation device 106.

Generally, the presentation device 106 can interface with a user via a user interface, and/or obtain and present media items and advertisements. For example, the presentation device 106 can select a channel from among multiple available channels, perhaps based on input received via a user interface, such that the presentation device 106 can select and/or obtain media on the selected channel. In some example, each such a channel may be associated with a given publisher and publisher system.

After the presentation device 108 obtains the media from the publisher system 102, the presentation device 106 can output the media for presentation. The presentation device 108 can output media for presentation in various ways. For example, in the case where the presentation device 106 is a television, outputting the media for presentation can involve the television outputting the media via a user interface (e.g., a display screen and/or a sound speaker), such that it can be presented to an end-user. As another example, in the case where the presentation device 106 is a media streaming player, outputting the media for presentation can involve the media streaming player outputting the media via a communication interface (e.g., an HDMI interface), such that it can be received by a television and in turn output by the television for presentation to an end-user. In other examples, the presentation device 106 can obtain and present advertisements, such as within a media selection menu of a user interface, as described in greater detail below.

In practice, the streaming-media system 100 is likely to include multiple publisher systems 102 (e.g., each corresponding to a different publisher), and as such, the decision engine 104 and/or presentation device 106 can be configured to obtain media content, media attribute data, and/or advertisements from one or more publisher systems. Likewise, in practice the streaming-media system 100 is likely to include multiple presentation devices 106 (e.g., each corresponding to a different user, or a different customer premises or rooms, for instance), and as such, in some examples, one or more publisher systems 102 and/or the decision engine 104 may all communicate with one or more different presentation devices 106.

More generally, in some instances, the streaming-media system 100 and/or components thereof can include multiple instances of at least some of the described components. The streaming-media system 100 and/or components thereof can take the form of a computing system, an example of which is described below.

### B. Computing System

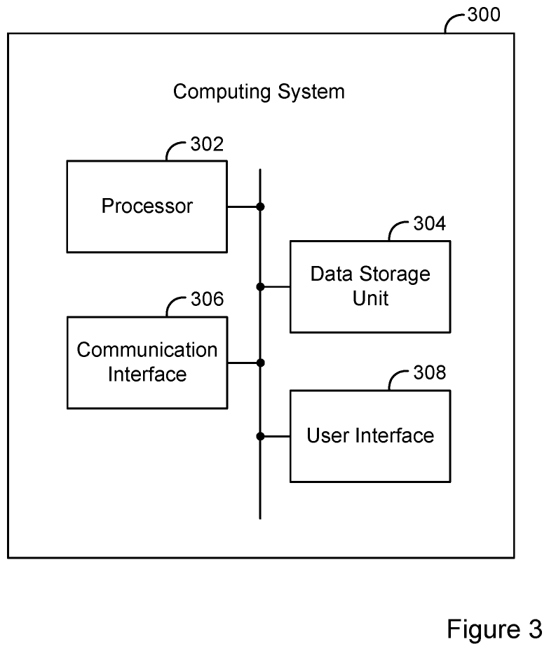

FIG. 3 is a simplified block diagram of an example computing system 300. The computing system 300 can be configured to perform and/or can perform various operations, such as the operations described in this disclosure. The computing system 300 can include various components, such as a processor 302, a data storage unit 304, a communication interface 306, and/or a user interface 308.

The processor 302 can be or include a general-purpose processor (e.g., a microprocessor) and/or a special-purpose processor (e.g., a digital signal processor). The processor 302 can execute program instructions included in the data storage unit 304 as described below.

The data storage unit 304 can be or include one or more volatile, non-volatile, removable, and/or non-removable storage components, such as magnetic, optical, and/or flash storage, and/or can be integrated in whole or in part with the processor 302. Further, the data storage unit 304 can be or include a non-transitory computer-readable storage medium, having stored thereon program instructions (e.g., compiled or non-compiled program logic and/or machine code) that, upon execution by the processor 302, cause the computing system 300 and/or another computing system to perform one or more operations, such as the operations described in this disclosure. These program instructions can define, and/or be part of, a discrete software application.

In some instances, the computing system 300 can execute program instructions in response to receiving an input, such as an input received via the communication interface 306 and/or the user interface 308. The data storage unit 304 can also store other data, such as any of the data described in this disclosure.

The communication interface 306 can allow the computing system 300 to connect with and/or communicate with another entity according to one or more protocols. Therefore, the computing system 300 can transmit data to, and/or receive data from, one or more other entities according to one or more protocols. In one example, the communication interface 306 can be or include a wired interface, such as an Ethernet interface or a High-Definition Multimedia Interface (HDMI). In another example, the communication interface 306 can be or include a wireless interface, such as a cellular or WI-FI interface.

The user interface 308 can allow for interaction between the computing system 300 and a user of the computing system 300. As such, the user interface 308 can be or include an input component such as a keyboard, a mouse, a remote controller, a microphone, and/or a touch-sensitive panel. The user interface 308 can also be or include an output component such as a display device (which, for example, can be combined with a touch-sensitive panel) and/or a sound speaker.

The computing system 300 can also include one or more connection mechanisms that connect various components within the computing system 300. For example, the computing system 300 can include the connection mechanisms represented by lines that connect components of the computing system 300, as shown in FIG. 3.

The computing system 300 can include one or more of the above-described components and can be configured or arranged in various ways. For example, the computing system 300 can be configured as a server and/or a client (or perhaps a cluster of servers and/or a cluster of clients) operating in one or more server-client type arrangements, such as a partially or fully cloud-based arrangement, for instance.

As noted above, the streaming-media system 100 and/or components of the streaming-media system 100 can take the form of a computing system, such as the computing system 300. In some cases, some or all of these entities can take the form of a more specific type of computing system, such as a desktop or workstation computer, a laptop, a tablet, a mobile phone, a television, a set-top box, a streaming media player, a head-mountable display device (e.g., virtual-reality headset or an augmented-reality headset), and/or a wearable device (e.g., a smart watch), among numerous other possibilities.

Although example architecture has been described above, the above-described components, systems, and/or other entities can be configured in various other ways as well. For example, the above-described components, systems, and/or other entities can be combined and/or split into different components, systems, and/or other entities, for instance.

### III. Example Operations

The streaming-media system 100, the computing system 300, and/or components of either can be configured to perform and/or can perform various operations, such as the example operations described below.

To begin, the decision engine 104 can obtain media attribute data from the publisher system 102. For instance, referring to the example data sets depicted in FIG. 2, in one example, the decision engine can obtain media attribute data A, media attribute data B, and media attribute data C from the publisher system 102. The publisher system 102 can provide and the decision engine 104 can obtain this information in various ways. For example, the publisher system 102 can provide such media attribute data in the form of a JSON or other type of text-based file, and the decision engine 104 can periodically run a crawler that monitors the file, such that it can keep and maintain a local file of media attribute data and related information. In some cases, the decision engine 104 can run a de-duplication service or other service to improve the integrity and/or reliability of such data. In practice, the decision engine 104 can perform these operations in connection with each of multiple different publisher systems 102, such that the decision engine can maintain a file that includes media attribute data for media content items provided by multiple different publishers. In this way, the decision engine 104 can provide search and recommendation services, among other things, for media items.

The decision engine 104 can also obtain user profile data, of which there can be various types. For example, user profile data can include demographic information, media preference information (e.g., data indicating a level of interest in certain media programs, genres, actors/actresses, etc.), language preference information, and/or historical viewing data for the user, among numerous other possibilities. Such user profile data can be obtained, stored, organized, and retrieved in various ways, such as by using any related user profile data techniques now known or later discovered. In some instances, user profile data can be obtained, stored, and/or used after the client has provided explicit permission for such operations to be performed. In some examples, the publisher system 102 can maintain and store user profile data, which the decision engine can obtain from the publisher system 102. Additionally or alternatively, the decision engine 104 can obtain user profile data from the presentation device 106 or from a user profile server that stores and maintains user profile data for various users of the streaming-media system 100, for example. In some instances, the decision engine 104 can combine various different user profile data that it obtains from these and other systems or devices.

The decision engine 104 can then use at least (i) the obtained media attribute data, and (ii) the obtained user profile data, as a basis to select the media item of the publisher system 102. For example, referring back to the example data sets depicted in FIG. 2, in the case where the obtained media attribute data includes the media attribute data A, the media attribute data B, and the media attribute data C, the decision engine 104 can use the obtained media attribute data and the user profile data to select the media item B.

The decision engine 104 can perform this media item selection operation in various ways. For example, the decision engine 104 can consider the obtained media attribute, the obtained user profile data, and/or a third-party popularity signal together with one or more predefined rules and/or conditions to determine which media item to select. In this way, the decision engine 104 can select a media item that is most appropriate in view of the user profile data and the media attribute data for multiple candidate media items. For example, where user profile data for a given user indicates that the user has an interest in a given movie, genre, actor/actress, etc. that information can be compared to media attribute data for multiple candidate media items, such that the decision engine 104 can select a media item that is a best match.

In some examples, the decision engine 104 can use other information as well as a basis to select the media item of the publisher system 102. For example, the decision engine 104 can additionally use a third-party popularity signal, such as a signal provided by an online movie and/or television show database that indicates an extent of popularity (e.g., represented as a popularity score within a given range, for example). The third-party may determine this extent of popularity in various ways, such as based on an extent to which users are conducting searches on its website for, and/or visiting webpages associated with, a given movie or television show, for instance. In these and other scenarios, a website server associated with the third-party website can send the signal in a suitable format to the decision engine 104, which can use the signal, perhaps together with the obtained media attribute data and the obtained user profile data, as a basis to select the media item of the publisher system 102. In some examples, this can cause the decision engine 104 to select advertisements for media items that may trending in the news, for example.

In some examples, the decision engine 104 can train a machine learning model by providing it with certain user profile data, media attribute data, and/or popularity signals, and media items as training input data, such that the decision engine 104 can then use the model in a runtime mode by providing it with user profile data, media attribute data, and/or popularity signals as input, resulting in the model providing output that indicates a media item selection.

After the decision engine 104 selects the media item of the publisher system 102, the decision engine 104 can then obtain from the publisher system 102, the advertisement that corresponds with the selected media item. For instance, referring to the example data sets depicted in FIG. 2, in one example where the decision engine 104 selects the media item B, the decision engine 104 can then obtain from the publisher system 102, the advertisement B. In some examples, the decision engine 104 can use mapping data (e.g., mapping data obtained from the publisher system 102), to map a given media item to a corresponding advertisement for that media item.

In some examples, the decision engine 104 can consider other data in connection with selecting and/or obtaining a media item and/or an advertisement. For example, the decision engine 104 can consider a budget, targeting criteria, advertisement quota, or other rule, condition, or other aspect of a one or more advertising campaigns. As such, the decision engine 104 can include appropriate modules such as publisher creative service, creative optimization, creative approval request, and advertisement screening service modules, among others. In this way, the streaming-media system 100 can select advertisements in manner that adheres to the overall goals of a given advertising campaign, for example.

After the decision engine 104 obtains the advertisement, the decision engine 104 can cause the presentation device 106 to present, within a media selection menu of the presentation device 106, the obtained advertisement. The decision engine 104 can do this in various ways. For example, the decision engine 104 can transmit the obtained advertisement and a suitable instruction to the presentation device 106, which the presentation device 106 can receive and use to trigger one or more associated presentation-related operations. Such operations could include the presentation device identifying a suitable advertisement placeholder within the media selection menu (which could be position in various places within the menu), and inserting the obtained advertisement in that placeholder, thereby generating and presenting a menu which includes the obtained advertisement.

In the context of a media selection menu, an advertisement placeholder (and therefore, the resulting inserted advertisement) can be positioned in various different areas within the menu. For instance, the advertisement could be positioned in an initial start-up or splash screen, such that the user is presented with an advertisement before proceeding to a home screen of the menu where the user can navigate through various media-related options. As another option, a given screen of the menu could include at least some distinct regions, including a first region that presents media items, or publisher channels, as various selectable options, and a second region that presents the advertisement, perhaps together with corresponding text or graphics, depending on certain information, such as the user's viewing history as it pertains to the media item being promoted by the advertisement. For instance, next to the advertisement, the menu could present text such as “Continue Watching . . . ” or “You Might Also Be Interested In XYZ,” where XYZ may identify a promoted media item that the user has watched, or perhaps a given genre, actor/actress name, etc.

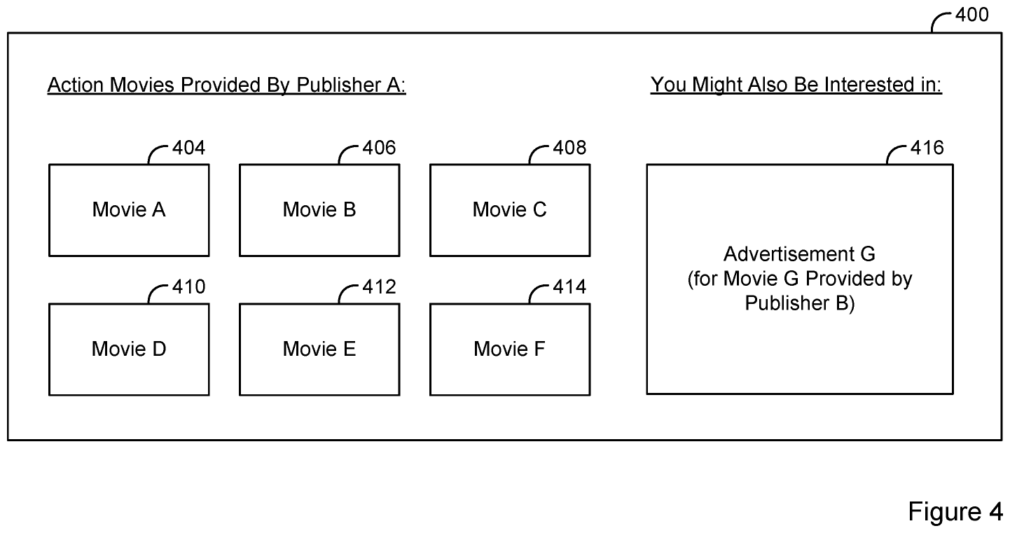

FIG. 4 is a screenshot 400 of an example portion of a media selection menu of a presentation device 106, which illustrates one example of how an advertisement could be presented. For context, it can be assumed that this portion of the menu is one that is provided to the user in response to the user requesting to view selectable action movie options provided by Publisher A. As shown, this portion of the menu includes several selectable Movies A-F (represented as 404, 406, 408, 410, 412, and 414) that when selected, cause the presentation device 106 to obtain the appropriate movie from a publisher system associated with Publisher A, and to present the obtained movie. However, the portion of the menu also includes a selectable Advertisement G (represented as 416) that when selected, causes the presentation device 106 to obtain the Advertisement G from a publisher system associated with Publisher B, and to present the obtained advertisement within the menu. Of course, this is just one example provided for illustration purposes. Many other configurations and/or arrangements for presenting advertisements within the context of a media selection menu are possible as well, such as in the various other ways described throughout this disclosure.

As noted above, in some instances, a given media item can have multiple corresponding advertisements (e.g., each having differing content, or a different size, aspect ratio, etc.), and as such, a given media item can correspond with a set of advertisements. In this case, the act of the decision engine 104 obtaining the advertisement that corresponds with the selected media item can involve obtaining multiple advertisements that correspond with the selected media item. The decision engine 104 can then use certain information as a basis to select, from among the multiple advertisements, an advertisement that is to be presented by the presentation device 106. For example, in one scenario where the advertisements differ in that each has different content (e.g., where one advertisement focuses on a given actor/actress in the media item, and another advertisement focuses on the genre of the media item), the decision engine 104 can use the user profile data as a basis to select one of the advertisements that may be the most relevant for that user.

In another scenario where the advertisements differ in that each has a different media type (e.g., where one takes the form of a low-resolution image, another takes the form of a high-resolution image, and another takes the form of a video), the decision engine 104 can user data relating to the technical characteristics of the presentation device 106 as a basis to select one the advertisements that may be most suitable in view of the technical capabilities of the presentation device 106. For instance, in the case where the presentation device 106 does not have sufficient memory or other resources to present video or a high-resolution image in the menu interface, the decision engine 104 might select the advertisement that is the low-resolution image in that instance.

In another scenario where the advertisements differ in that each has a different display attribute (e.g., where each has a different size, shape, aspect ratio, etc.), the decision engine 104 can use a placeholder attribute of the media selection menu as a basis to select the advertisement that may be most suitable in view of the placeholder limitations. For instance, in the case where the placeholder is a placeholder for an image of with a 3:2 aspect ratio, this may cause the decision engine 104 to select the one of the multiple candidate advertisements that has that same aspect ratio.

In some examples, in the case where the decision engine 104 selects multiple advertisements, rather than selecting one advertisement from among the multiple advertisements, the decision engine 104 can instead cause the presentation device 106 to present, within the media selection menu of the presentation device 106, the obtained multiple advertisements. The presentation device 106 can do this in various ways. For example, the presentation device 106 can use the multiple advertisements to generate a composite image that includes each of the multiple advertisements together. For instance, in the case where the multiple advertisements are images, the presentation device 106 can combine the images side by side, or one above another, etc. In another example, the presentation device 106 can use the multiple advertisements to generate a rotating advertisement (e.g., in the form of a short video) that rotates through the multiple advertisements in a carousal-type fashion. In some examples, rather than the decision engine 104 providing the multiple images to the presentation device 106 and the presentation device 106 combining them together, the decision engine 104 can do so itself, and can provide the combined advertisement to the presentation device 106.

After the presentation device 106 presents the advertisement, the presentation device 106 can select the presented advertisement, based on input received via a user interface of the presentation device 106. In practice, this can involve a user using a remote control device or other input device to navigate through the media selection menu, and to select the presented advertisement. Responsive to the selecting the advertisement, the presentation device 106 can (i) obtain from the publisher system 102, the media item corresponding to the advertisement, and (ii) present the obtained media item. In some example, the advertisement can include or be associated with metadata indicating the media item and/or information that can be used to obtain the media item. For instance, the advertisement can include metadata in the form of URL or other type of link that points to a data storage unit or location of the publisher system 102 where the media item is stored, such that the presentation device 106 can stream or otherwise obtain the media item from the publisher system 102.

As noted above, in some examples, in the case where the decision engine 104 selects multiple advertisements, rather than selecting one advertisement from among the multiple advertisements, the decision engine 104 can instead cause the presentation device 106 to present, within the media selection menu of the presentation device 106, the obtained multiple advertisements. Similarly, in the context of the decision engine 104 using at least (i) the obtained media attribute data, (ii) the obtained user profile data, and/or (iii) a third-party popularity signal, as a basis to select the media item of the publisher system 106, the decision engine 104 can use some or all of this data as a basis to select multiple media items of the publisher system 106, such that the decision engine 104 can obtain multiple advertisements (each of which corresponds to a respective one of the selected media items), which can be presented within the media selection menu of the presentation device 106, such as in the various ways described above (e.g., with the multiple advertisements being combined into a composite image or shown in a rotating fashion, etc.). In these scenarios, the advertisement can include metadata in the form of a URL or other type of link that points to a data storage unit or location of the publisher system 102 where one or more of the media item is stored. In some instances, in response to the user selecting such an advertisement, the presentation device 106 can prompt the user to select which one of the multiple media items the user intends to watch, such that the presentation device 106 can use the appropriate metadata to obtain and present that particular media item.

This example technique of the decision engine 104 obtaining multiple advertisements for multiple media items of a common publisher, which can be presented within the media selection menu of the presentation device 106, can have various practical applications. For instance, in the case where a user profile indicates that the user has an interest in a given actor/actress, and that actor/actress is associated with multiple media items provided by a single publisher, the decision engine 104 can use user profile data, media attribute data, etc. as a basis to select those media items and corresponding advertisements, which can be presented via the menu, with a message to the user such as “Based on your interest in actor/actress H, you may be interested in Publisher I who offered these media items J, K, and L,” as such, the presentation device 106 can present an advertisement for media items J, K, and L, and/or more generally, for Publisher L. Various other example use cases are possible as well.

In some instances, the streaming-media system 100 can include a reporting and/or editing system component that keeps records of the data and related operations discussed above, that generates related reports, and/or that allows a user to review, approve, reject, and/or edit various operations or results of operations. Among other things, could be used to generate various reports, such as reports showing which advertisements were selected in presented, based on what data, perhaps on a user-by-user, device-by-device, or on an aggregate-type basis. In addition, the 100 could provide for generating certain reports as part of a quality assurance process.

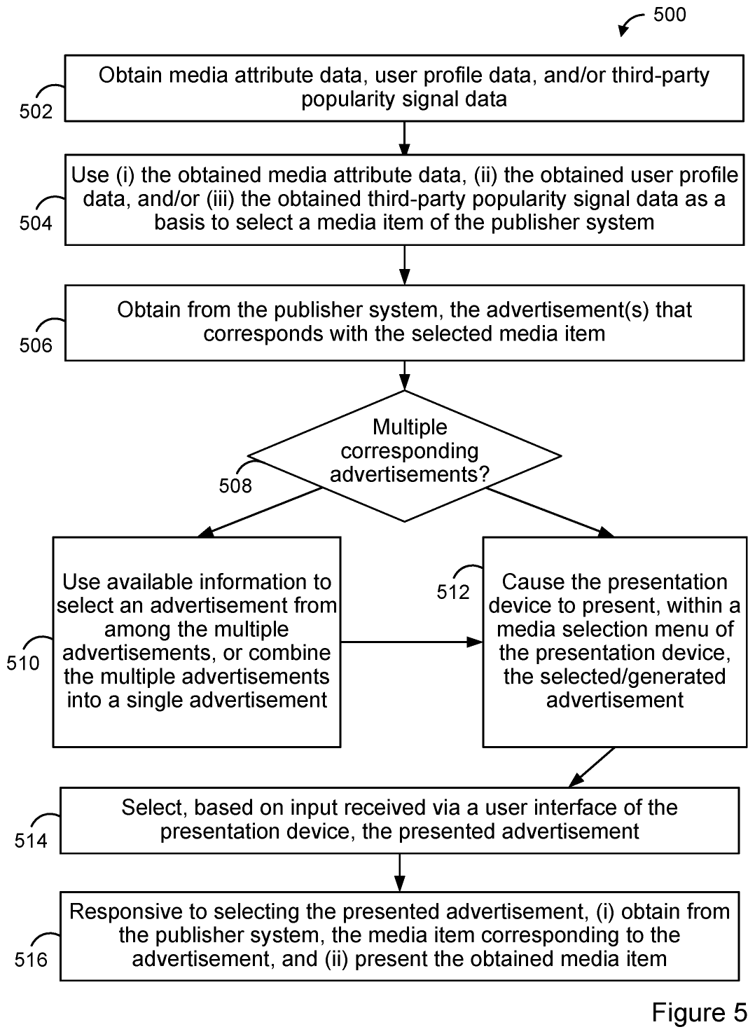

FIG. 5 is a flow chart illustrating an example method 500 for use in connection with a streaming-media system comprising a publisher system and a presentation device, wherein the publisher system includes one or more data storage components that store media items, respective media attribute data, and respective advertisements. The method 500 can be carried out by the streaming-media system, such as the streaming-media system 100 and/or by components thereof, such as the decision engine 104, the presentation device 106, or more generally, by a computing system, such as the computing system 300. At block 502, the method 500 includes obtaining media attribute data, user profile data, and/or third-party popularity signal data. At block 504, the method includes using at least (i) the obtained media attribute data, (ii) the obtained user profile data, and/or (iii) the obtained third-party popularity signal data as a basis to select a media item of the publisher system. At block 506, the method includes obtaining from the publisher system, the advertisement(s) that corresponds with the selected media item. If there are multiple advertisements selected, at block 510, the method includes using available information to select an advertisement from among the multiple advertisements, or combining the multiple advertisements into a single advertisement. Then, or if only a single a single advertisement was selected at block 506, at block 512, the method includes causing the presentation device to present, within a media selection menu of the presentation device, the selected/generated advertisement. At block 514, the method includes selecting based on input received via a user interface of the presentation device, the presented advertisement. And at block 516, the method includes responsive to selecting the presented advertisement: (i) obtaining from the publisher system, the media item corresponding to the advertisement; and (ii) presenting the obtained media item.

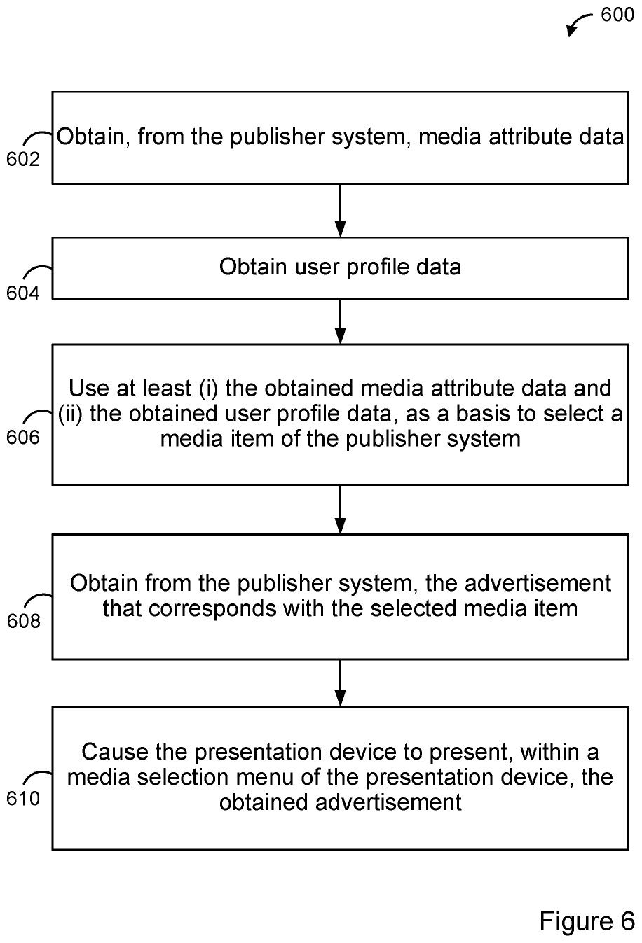

FIG. 6 is a flow chart illustrating an example method 600 for use in connection with a streaming-media system comprising a publisher system and a presentation device, wherein the publisher system includes one or more data storage components that store media items, respective media attribute data, and respective advertisements. The method 600 can be carried out by the streaming-media system, such as the streaming-media system 100 and/or by components thereof, such as the decision engine 104, the presentation device 106, or more generally, by a computing system, such as the computing system 300. At block 602, the method 600 includes obtaining, from the publisher system, media attribute data. At block 604, the method includes obtaining user profile data. At block 606, the method includes using at least (i) the obtained media attribute data and (ii) the obtained user profile data, as a basis to select a media item of the publisher system. At block 608, the method includes obtaining from the publisher system, the advertisement that corresponds with the selected media item. And at block 610, the method includes causing the presentation device to present, within a media selection menu of the presentation device, the obtained advertisement.

In some examples, the selected media item can be a movie or a television show episode, the obtained media attribute data can be a popularity ranking, and/or the obtained user profile data can be user demographic data or user historical viewing data.

In some examples, obtaining the user profile data comprises obtaining the user profile data from the publisher system.

In some examples, using at least (i) the obtained media attribute data and (ii) the obtained user profile data, as a basis to select the media item of the publisher system comprises using at least (i) the obtained media attribute data, (ii) the obtained user profile data, and (iii) a third-party popularity signal, as a basis to select the media item of the publisher system.

In some examples, obtaining the advertisement that corresponds with the selected media item comprises obtaining multiple advertisements that correspond with the selected media item, and the method can further include using a placeholder attribute of the media selection menu as a basis to select an advertisement from among the multiple advertisements. In this case, causing the presentation device to present, within the media selection menu of the presentation device, the obtained advertisement comprises causing the presentation device to present, within the media selection menu of the presentation device, the selected advertisement.

In some examples, the placeholder attribute can be a size or aspect ratio of an image or video placeholder.

In some examples, using at least (i) the obtained media attribute data and (ii) the obtained user profile data, as a basis to select a media item of the publisher system comprises using at least (i) the obtained media attribute data and (ii) the obtained user profile data, as a basis to select multiple media items of the publisher system; obtaining the advertisement that corresponds with the selected media item comprises obtaining the multiple advertisements that correspond with the selected multiple media items; and causing the presentation device to present, within the media selection menu of the presentation device, the obtained multiple advertisements.

In some examples, causing the presentation device to present, within the media selection menu of the presentation device, the obtained multiple advertisements comprises causing the presentation device to present, within the media selection menu of the presentation device, a composite advertisement including the obtained multiple advertisements.

In some examples, causing the presentation device to present, within the media selection menu of the presentation device, the obtained multiple advertisements comprises causing the presentation device to present, within the media selection menu of the presentation device, a rotating advertisement that rotates through the obtained multiple advertisements.

In some examples, the method can further include selecting based on input received via a user interface of the presentation device, the presented advertisement; and responsive to selecting the presented advertisement: (i) obtaining from the publisher system, the media item corresponding to the advertisement; and (ii) presenting the obtained media item.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method for use in connection with a streaming-media system comprising a publisher system and a presentation device, wherein the publisher system includes one or more data storage components that store media items, respective media attribute data, and respective advertisements, the method comprising:
obtaining, from the publisher system, media attribute data;
obtaining user profile data;
using at least (i) the obtained media attribute data and (ii) the obtained user profile data, as a basis to select a media item of the publisher system;
obtaining from the publisher system, the advertisement that corresponds with the selected media item; and
causing the presentation device to present, within a media selection menu of the presentation device, the obtained advertisement.

2. The method of claim 1, wherein the selected media item is a movie or a television show episode.

3. The method of claim 1, wherein the obtained media attribute data is a popularity ranking.

4. The method of claim 1, wherein the obtained user profile data is user demographic data or user historical viewing data.

5. The method of claim 1, wherein obtaining the user profile data comprises obtaining the user profile data from the publisher system.

6. The method of claim 1, wherein using at least (i) the obtained media attribute data and (ii) the obtained user profile data, as a basis to select the media item of the publisher system comprises using at least (i) the obtained media attribute data, (ii) the obtained user profile data, and (iii) a third-party popularity signal, as a basis to select the media item of the publisher system.

7. The method of claim 1, wherein obtaining the advertisement that corresponds with the selected media item comprises obtaining multiple advertisements that correspond with the selected media item;
wherein the method further comprises using a placeholder attribute of the media selection menu as a basis to select an advertisement from among the multiple advertisements; and
wherein causing the presentation device to present, within the media selection menu of the presentation device, the obtained advertisement comprises causing the presentation device to present, within the media selection menu of the presentation device, the selected advertisement.

8. The method of claim 7, wherein the placeholder attribute is a size or aspect ratio of an image or video placeholder.

9. The method of claim 1, wherein using at least (i) the obtained media attribute data and (ii) the obtained user profile data, as a basis to select a media item of the publisher system comprises using at least (i) the obtained media attribute data and (ii) the obtained user profile data, as a basis to select multiple media items of the publisher system;
wherein obtaining the advertisement that corresponds with the selected media item comprises obtaining the multiple advertisements that correspond with the selected multiple media items; and
causing the presentation device to present, within the media selection menu of the presentation device, the obtained multiple advertisements.

10. The method of claim 9, wherein causing the presentation device to present, within the media selection menu of the presentation device, the obtained multiple advertisements comprises causing the presentation device to present, within the media selection menu of the presentation device, a composite advertisement including the obtained multiple advertisements.

11. The method of claim 9, wherein causing the presentation device to present, within the media selection menu of the presentation device, the obtained multiple advertisements comprises causing the presentation device to present, within the media selection menu of the presentation device, a rotating advertisement that rotates through the obtained multiple advertisements.

12. The method of claim 1, further comprising:
selecting based on input received via a user interface of the presentation device, the presented advertisement; and
responsive to selecting the presented advertisement:
(i) obtaining from the publisher system, the media item corresponding to the advertisement; and
(ii) presenting the obtained media item.

13. A computing system comprising a processor and a non-transitory computer-readable storage medium having stored thereon program instructions that upon execution by the processor, cause the computing system to perform a set of acts for use in connection with a streaming-media system comprising a publisher system and a presentation device, wherein the publisher system includes one or more data storage components that store media items, respective media attribute data, and respective advertisements, the set of acts comprising:
obtaining, from the publisher system, media attribute data;
obtaining user profile data;
using at least (i) the obtained media attribute data and (ii) the obtained user profile data, as a basis to select a media item of the publisher system;
obtaining from the publisher system, the advertisement that corresponds with the selected media item; and
causing the presentation device to present, within a media selection menu of the presentation device, the obtained advertisement.

14. The computing system of claim 13, wherein using at least (i) the obtained media attribute data and (ii) the obtained user profile data, as a basis to select the media item of the publisher system comprises using at least (i) the obtained media attribute data, (ii) the obtained user profile data, and (iii) a third-party popularity signal, as a basis to select the media item of the publisher system.

15. The computing system of claim 13, wherein obtaining the advertisement that corresponds with the selected media item comprises obtaining multiple advertisements that correspond with the selected media item;
wherein the set of acts further comprises using a placeholder attribute of the media selection menu as a basis to select an advertisement from among the multiple advertisements; and
wherein causing the presentation device to present, within the media selection menu of the presentation device, the obtained advertisement comprises causing the presentation device to present, within the media selection menu of the presentation device, the selected advertisement.

16. The computing system of claim 13, wherein obtaining the advertisement that corresponds with the selected media item comprises obtaining multiple advertisements that correspond with the selected media item;
wherein the set of acts further comprises using a placeholder attribute of the media selection menu as a basis to select an advertisement from among the multiple advertisements; and
wherein causing the presentation device to present, within the media selection menu of the presentation device, the obtained advertisement comprises causing the presentation device to present, within the media selection menu of the presentation device, the selected advertisement.

17. The computing system of claim 16, wherein causing the presentation device to present, within the media selection menu of the presentation device, the obtained multiple advertisements comprises causing the presentation device to present, within the media selection menu of the presentation device, a composite advertisement including the obtained multiple advertisements.

18. The computing system of claim 16, wherein causing the presentation device to present, within the media selection menu of the presentation device, the obtained multiple advertisements comprises causing the presentation device to present, within the media selection menu of the presentation device, a rotating advertisement that rotates through the obtained multiple advertisements.

19. The computing system of claim 13, the set of acts further comprising:
selecting based on input received via a user interface of the presentation device, the presented advertisement; and
responsive to selecting the presented advertisement:
(i) obtaining from the publisher system, the media item corresponding to the advertisement; and
(ii) presenting the obtained media item.

20. A non-transitory computer-readable storage medium having stored thereon program instructions that upon execution by a processor, cause a computing system to perform a set of acts for use in connection with a streaming-media system comprising a publisher system and a presentation device, wherein the publisher system includes one or more data storage components that store media items, respective media attribute data, and respective advertisements, the set of acts comprising:
obtaining, from the publisher system, media attribute data;
obtaining user profile data;
using at least (i) the obtained media attribute data and (ii) the obtained user profile data, as a basis to select a media item of the publisher system;
obtaining from the publisher system, the advertisement that corresponds with the selected media item; and
causing the presentation device to present, within a media selection menu of the presentation device, the obtained advertisement.
